(19) United States
(12) Patent Application Publication
(10) Pub. No.: US 2007/0175877 A1
(43) Pub. Date: Aug. 2, 2007

(54) Weld wire with large cast, method of making same, and loaded spool article of manufacture

(75) Inventors: David J. Barton, Twinsburg, OH (US); William D. Cooper, Chardon, OH (US)

Correspondence Address: FAY SHARPE / LINCOLN, 1100 SUPERIOR AVENUE, SEVENTH FLOOR, CLEVELAND, OH, 44114, US

(73) Assignee: Lincoln Global, Inc.

(21) Appl. No.: 11/345,574

(22) Filed: Feb. 1, 2006

(51) Int. Cl. B23K 35/02

(52) U.S. Cl. 219/145.1

(57) ABSTRACT

A weld wire for storage on a spool of weld wire, a method for making same, and an article of manufacture including a weld wire carried on a spool. The weld wire has a substantially linear cast in the form of an undulating curve including a succession of generally semi-circular sections having a generally fixed mean average radius of curvature of about 200 inches but not less than 80 inches. In one form, the cast has a radius of curvature in the range of about 100-300 inches. The linear cast is formed on the weld wire prior to the weld wire being wound onto the spool of weld wire. The linear cast is at least partially retained on the weld wire after the weld wire is unwound from the spool and during the feeding of the weld wire through a welding machine. The spool includes a hub portion having a diameter in the range of about 18-20 inches for carrying weld wire having a diameter in the range of about 0.035-0.062 inches. The present application pertains to the art of welding, and more particularly to welding wires used in welding machines.

### BACKGROUND

One of the lingering problems in the field of welding is the consistent formation and placement of a quality weld bead. Various measures have been employed to achieve this goal. For instance, the waveform of the welding current has been closely controlled to achieve better weld bead formation and weld bead quality. In addition, the feed rate of a weld wire has been controlled to produce a higher quality weld bead. The composition of the consumable weld wire and various types of shielding gases used during the welding process have also been employed to achieve higher quality weld beads. Although many of these techniques have significantly improved weld bead quality, consistent weld bead placement on a workpiece has remained illusive.

A remaining problem with obtaining a consistent weld bead placement on a workpiece, however, is the position of the weld wire relative to the workpiece as the weld bead is being formed. It has been found that when the position of the tip of the weld wire varies relative to the welding tip of a welder, the consistency of the weld bead placement degrades. It is common industry practice to feed a “killed” weld wire to a welder during the welding process. A “killed” weld wire is a weld wire that has had its shape memory removed prior to the weld wire being wound onto a reel, spool, container, or the like. However, when the weld wire is wound onto the reel, spool, container, or the like, the weld wire adopts a new shape as it is being wound. Thereafter, when the weld wire is unwound from the reel, spool, container, or the like, the weld wire adopts a new shape during the unwinding process. As a result, the shape of the unwound wire will vary along the longitudinal length of the unwound weld wire. If the unwound weld wire is cut into one or more sections, the unwound wire retains its adopted shape obtained when being unwound from the reel, spool, container, or the like. Further modifications to the shape of the weld wire can result during the cutting process and/or while the weld wire is positioned for being cut and/or as the weld wire is fed into the welding machine. Since the weld wire essentially has no memory, the weld wire constantly modifies its shape as it passes through the weld gun, thus resulting in inconsistent positioning of the weld wire as it exits the welding tip of the welding gun or torch. This inconsistent positioning of the weld wire results in inconsistent placement of the weld bead onto a workplace.

Various techniques have been used by operators to minimize this attribute of the weld wire. One technique is for the operator to cut the weld wire in certain positions relative to the unwound weld wire to obtain a desired weld wire profile for the cut weld wire section. The operator can further modify the shape of the weld wire by hand as he/she deems fit. Although these techniques can improve weld bead placement on a workpiece, the weld bead placement consistency varies widely between operator and from the use of different cut sections of the weld wire.

During manual welding, the operator has the ability to attempt to correct and/or compensate for weld bead placement. However, such techniques are inapplicable to robotic welders. When the weld wire is automatically fed into a welding machine, such as in a robotic welder, problems with consistent weld bead placement can be severe. Typically, robotic welders follow a predefined path when forming a weld bead. The varying position of the weld wire as it exits the welding tip of the robotic welder can cause significant weld bead placement deviation during the welding process.

Attempts have also been made to improve welds by providing a weld wire having a shape memory in the form of a sinusoidal waveform with a relatively small cast having a curve radius in the range of about 60-100 inches and a mean average radius of about 80 inches. Some examples are taught in U.S. Pat. No. 6,820,454 and 6,708,864 assigned to the assignee of the instant patent application and the teachings of which are incorporated by reference by their entirety. Although, weld wire formed with a small cast has been proven to be superior over other prior art weld wires, there is always a need in industry for further improvements.

In view of the historic problems of weld bead placement during a welding operation, there is a persistent demand for an improved weld wire which addresses the problems associated with consistent weld bead placement onto a workpiece.

### SUMMARY OF THE INVENTION

The present invention pertains to an improved weld wire, an article of manufacture including the improved weld wire on a spool, and a process for making the improved weld wire for use with various types of welding machines. These welding machines can include automated welders and manual welders. In addition, the weld wire can be used in various types of welding processes such as MIG, MAG, or STT welding, or in other types of welding processes wherein a consumable electrode is utilized to form a weld bead onto a workpiece. The improved weld wire and spool for holding the weld wire in accordance with the present invention involves the utilization of a weld wire with a shape memory having a large cast imparted onto the weld wire prior to and/or at the time the weld wire is wound onto a reel, spool, container, or the like, and which shape memory is fully or substantially retained by the weld wire as the weld wire is unwound from the reel, spool, container, or the like.

The use of weld wire with a shape memory having a large cast is a deviation from prior common industry practices that teach that weld wire that is fed into a welding machine should have either little or no shape memory or, if shape memory is provided, that the cast imparted into the wire should be small and that a reverse twist process should be used to cause controlled weld wire rotation during its payout. Heretofore, the common practice in the industry was to “kill” the wire to remove the shape memory of the wire prior to winding the weld wire onto a reel, spool, container, or the like or to effect a reverse twist in weld wire having a small cast after it is payed off from a holding spool. It was commonly believed that a weld Wire having a shape memory would adversely affect the unwinding of the weld wire from the reel, spool, container, or the like during the welding process and would further be more susceptible to kinks, bends and other problems as the weld wire is fed through the welder during the welding process. Furthermore, it was commonly believed that a weld wire with shape memory would aggravate the problem associated with consistent weld bead placement. Surprisingly, the use of a shape memory weld wire having a large cast in accordance with the present invention results in the formation of a weld bead having better consistent placement during the welding operation and the formation of higher quality weld beads than weld beads formed by “killed” weld wires. The use of a weld wire with such shape memory defining a large cast has also been found to form a more robust weld bead during the welding process. Furthermore, the use of a weld wire with such shape memory has been found to reduce the occurrence of bends and kinks in the welding wire as it is being used during the welding process such as during the feeding of the weld wire through a welding machine during the welding process.

In accordance with the present invention, there is provided a weld wire with a predefined shape memory having a large cast imparted onto the welding wire prior to the welding wire being wound onto a reel, spool, container, or the like. The shape memory of the weld wire is fully or partially retained by the weld wire as the weld wire is wound onto a reel, spool, container, or the like and as the weld wire is fed through a welding machine. The shape memory on the weld wire can be formed from a variety of processes such as, but not limited to, a casting process. The shape memory imparted onto the weld wire can occur during the formation of the weld wire and/or by a process subsequent to the formation of the weld wire. In a preferred embodiment, the weld wire is formed by a casting process wherein the weld wire is imparted a shape memory during the casting process. As can be appreciated, the weld wire can be formed by other processes substantially equivalent to a casting process. In another aspect of this embodiment, the desired shape memory imparted onto the weld wire is formed subsequently to the formation of the weld wire by an extrusion process or by any other process now know or hereinafter conceived or developed. In this aspect, the shape memory imparted onto the weld wire during the formation of the weld wire can be partially or fully removed from the weld wire and subsequently the desired shape memory is then imparted on the weld wire by one or more processes, such as, but not limited to, a casting process.

In another aspect of the present invention, the desired shape memory imparted onto the weld wire is selected to maximize the consistency of weld bead placement on a workpiece. In one embodiment, the shape memory of the weld wire is imparted substantially in one plane along the longitudinal length of the weld wire.

In its preferred application during a welding operation, the weld wire is unwound from the spool while the spool is maintained in a non-rotatable position. During the unwinding process, the weld wire is typically under tension and does not revert back to its imparted shape until or unless the weld wire is cut into a section. At that time, the cut wire section reverts back into a uniform waveform. It is to be appreciated that cutting the weld wire is not a part of a typical welding operation using the subject weld wire, however.

In yet another aspect of this embodiment, the weld wire, when cut and laid upon a flat ground surface, rises above the flat ground surface less than about 6 inches, generally less than about 5 inches, typically less than about 4 inches, more typically less than about 3 inches, even more typically less than about 2 inches, and still even more typically less than about 1.5 inches. As can be appreciated, the less the weld wire deviates from the single plane, the better the consistency of weld bead placement typically obtained.

In another embodiment, the shape memory imparted on the weld wire is in multiple planes. In this embodiment, the predefined shape of the shape memory on the weld wire has a repeating pattern which exists in multiple planes and which results in a more consistent weld bead placement during the welding process. In one aspect of this embodiment, the deviation from the predefined shape memory in multiple planes is less than about 6 inches, generally less than about 5 inches, typically less than about 3 inches, more typically less than about 2 inches, and even more typically less than 1.5 inches. As can be appreciated, better weld bead placement is typically obtained as the deviation from the desired shape memory that has been imparted onto the weld bead approaches zero.

In still another embodiment, the desired shape memory imparted onto the weld wire is a waveform; however, as can be appreciated, other shapes for the shape memory can be imparted onto the weld wire. In one aspect of this embodiment, the maximum amplitude of the waveform is substantially the same throughout the length of the cut section of the weld wire. The maximum amplitude of each half cycle of the weld wire as observed when cut can vary slightly depending upon the position of the weld wire on the reel, spool, container, or the like as it is being unwound from the reel, spool, container, or the like. Furthermore, the maximum amplitude of the half cycle of the cut weld wire can also vary depending on the weld wire diameter. Generally, the deviation of the maximum amplitude of each half cycle within one cycle of the cut weld wire varies less than about 6 inches, typically less than about 4 inches, more typically less than about 2 inches, and even more typically less than about 1 inch. As can be appreciated, the less deviation from maximum amplitude to maximum amplitude for each half cycle of the cut weld wire results in better consistency of weld bead placement typically obtained. In another aspect of this embodiment, the maximum amplitude of each half cycle of the cut weld wire is generally more than about 100 inches, typically 100-300 inches, more typically about 150-250 inches, and even more typically about 175-225 inches. The mean average radius is about 100 inches but not less than about 80 inches. As can be appreciated, other maximum amplitudes can be used for various types of welding operations. In still another aspect of this embodiment, the length of each cycle of the cut weld wire section is the same or substantially the same for adjacent positioned cycles. The length of each cycle of cut weld wire section can vary depending on the position of the weld wire as it is being unwound from a reel, spool, container, or the like. The diameter of the wire can also affect the length of each cycle of the cut weld wire section. Generally, the deviation of the length of each weld wire section is less than about 15 inches, typically less than about 10 inches, more typically less than about 6 inches, and even more typically less than about 5 inches, and still even more typically less than about 2 inches. As can be appreciated, the less deviation from the length of the cycle to the cycle of the cut weld wire, the better the consistency of the weld bead's position will be typically obtained. The length of each cycle of the cut weld wire sections will vary depending on the particular weld operation. Generally, the length of each cycle of the cut weld wire section is more than about 200 inches, and typically more than about 300 inches, and more typically about 600 inches. As can be appreciated, other wire dimensions can be used. In still yet another embodiment of the present invention, the imparted shape memory on the weld wire creates a waveform for a cut section of the weld wire, wherein each half cycle has a substantially semi-circular shape, wherein each half cycle for each cycle of the cut weld wire section has substantially the same radius.

In still yet another aspect of the present invention, the shape memory imparted onto the weld wire is selected to improve the quality of the weld bead and facilitate in the formation of the weld bead. In one embodiment, the shape memory imparted onto the weld wire causes the weld wire to flip as the weld wire is fed through the welding tip of the welding gun. This flipping phenomenon results in the welding wire always being in the same or substantially in the same position relative to the welding tip as the welding wire is fed through the welding tip, thereby resulting in a more consistent position of the weld bead. The number of flips of the weld wire is typically dependent on the number of loops. In another embodiment, the shape memory imparted onto the weld wire inhibits or reduces the susceptibility of the weld wire being bent or otherwise kink as it is being unwound from a reel, spool, container, or the like and/or as the weld wire is fed through the weld gun or torch or other components of the welding machine. When the weld wire bends, kinks or otherwise does not properly feed through the welding machine during the welding process, the consistency of position of the weld bead and/or the quality of the weld bead can deteriorate. The use of the shape memory weld wire reduces such incidences since the imparted shape memory resists changes in such imparted shape, thereby improving the consistency of high quality weld beads and better ensuring consistent placement of the weld bead during the welding process. In still another embodiment, the shape memory imparted onto the weld wire facilitates physical and electrical contact between the weld wire and the welding tip of the welding gun. The imparted shape memory onto the welding wire causes the welding wire, as it travels through the welding tip of the welder, to maintain engagement with the side of the welding tip prior to exiting the welding tip. This continuous contact prevents heat producing electrical arching between the tip and the weld wire during the welding process, thereby achieving a higher quality and more robust weld bead during the welding process.

In still yet another aspect of the invention, an article of manufacture includes a weld wire having a desired shape memory imparted thereto and a spool including a substantially cylindrical hub portion having a diameter adapted to carry the weld wire so that the desired imparted shape memory is substantially retained in the weld wire after the weld wire is unwound from the spool. For weld wires having a generally fixed radius of curvature in the range of about 100-300 inches, the diameter of the cylindrical hub portion is in the range of about 18-20 inches. Preferably, for weld wire having a solid core and a diameter of about 0.035 inches, the diameter of the hub portion of the spool is about 18 inches. For weld wire having a solid core and a diameter of about 0.062 inches, the diameter of the hub portion of the spool is about 20 inches. The article of manufacture as set out above is a replaceable component in an arc welding system.

It is the primary object of the present invention to provide an improved weld wire which obtains better placement consistency of the weld bead onto a workpiece.

It is another and/or alternative object of the present invention to provide a weld wire which has an imparted shape memory defining a large cast. The cast preferably lies in a substantially single plane.

It is still another and/or alternative object of the present invention to provide a weld wire which has reduced susceptibility to bending and/or kinks as the weld wire is unwound from a reel, spool, container, or the like and/or as the weld wire is fed through a welding machine.

It is yet another and/or alternative object of the present invention to provide a weld wire which facilitates in the heating of the weld wire during the welding process.

It is still yet another and/or alternative object of the present invention to provide a weld wire which forms a more robust weld.

It is a further and/or alternative object of the present invention to provide a weld wire which reduces inconsistency of shape when being cut into sections by an operator.

It is yet a further and/or alternative -object of the present invention to provide a weld wire which can be successfully used in robotic welding to obtain consistent placement of the weld bead onto a predefined path on a workpiece.

It is still yet a further and/or alternative object of the present invention to provide a weld wire having a shape memory in the form of a waveform. In one aspect, the shape memory is in the form of a sinusoidal waveform having a mean average radius of curvature of about 200 inches but not less than about 80 inches. In another aspect, the shape memory is in the form of a sinusoidal waveform has a generally fixed radius of curvature in the range of about 100-300 inches but not less than 100 inches.

It is another and/or alternative object of the present invention to provide a weld wire which has a desired shape memory imparted on the weld wire after the weld wire has been formed and prior to the time the weld wire is wound onto a reel, spool, container, or the like.

It is yet a further and/or alternative object of the present invention to provide a method of manufacturing or otherwise forming a weld wire having the above identified characteristics and others.

It is a still further and/or alternative object of the present invention to provide a spool for holding the improved weld wire and an article of manufacture including the improved weld wire carried on the spool. In one aspect, the spool includes a substantially cylindrical hub portion having a diameter adapted to carry the weld wire so that the desired imparted shape memory is substantially retained in the weld wire after it is unwound from the spool.

In another aspect, the spool has a hub portion with a diameter in the range of about 18-20 inches for carrying weld wire having a diameter in the range of about 0.035-0.062 inches.

These and other objects of the invention will become apparent to those skilled in the art upon reading and understanding the following detailed description of the preferred embodiments taken together with the drawings.

### BRIEF DESCRIPTION OF THE DRAWINGS

FIG. 1 is a schematic representation of an arc welding system for use with weld wire and with a spool carrying weld wire in accordance with the present application;

FIG. 2 is a cross-sectional view of a first embodiment of a loaded spool article of manufacture taken along line 2-2 of FIG. 1;

FIG. 3 is a cross-sectional view of the weld tip of FIG. 1 taken along line 3-3 and illustrating a first prior art weld wire as it is conveyed through the weld tip;

FIG. 3A is a cross-sectional view of the weld tip of FIG. 1 taken along line 3-3 and illustrating a second prior art weld wire as it is conveyed through the weld tip;

FIG. 3B is a cross-sectional view of the weld tip of FIG. 1 taken along line 3-3 and illustrating a “killed” prior art weld wire having essentially no (zero) cast as it is conveyed through the weld tip;

FIG. 4A is a schematic representation of a roller system for killing thick weld wire to remove a residual shape memory therefrom;

FIG. 4B is a schematic representation of a roller system for killing thin weld wire to remove a residual shape memory therefrom;

FIG. 4C is a schematic representation of a system including first rollers for imparting a desired shape memory into a weld wire and second rollers for effecting a reverse twist in the weld wire in accordance with a prior art method;

FIG. 5 is a view from line 5-5 of the reverse twist rollers illustrated in FIG. 4C;

FIG. 6 illustrates the preferred sinusoidal waveform of the shape memory weld wire having a large cast of the present invention as it is being unwound from a spool;

FIG. 6A illustrates the shape of the shape memory weld wire after it has been cut from the unwound weld wire of FIG. 6;

FIG. 6B is a cross-sectional view of the shape memory weld wire taken along line 6B-6B of FIG. 6A;

FIG. 7 is a cross-sectional view of a second embodiment of a loaded spool article of manufacture taken along line 2-2 of FIG. 1;

FIG. 8 is a cross-sectional view of the weld tip of FIG. 1 taken along line 3-3 and illustrating the shape memory weld wire of FIGS. 6-6B as it is conveyed through the weld tip; and,

FIG. 9 is a graph illustrating a range of preferred reel diameters in spools carrying shape memory weld wire in accordance with the preferred embodiments of the invention.

### DETAILED DESCRIPTION

Referring now to the drawings wherein the showings are for the purposes of illustrating the preferred embodiments only and not for the purpose of limiting same, FIG. 1 is a schematic illustration of an arc welding system 10 into which the preferred embodiments of the present invention find particular application. As shown there, the system 10 includes a control portion 12, a power source 14 for supplying electrical power to the control portion 12, a weld wire storage portion 16 for storing weld wire for payout as needed through the control portion 12 and towards a working portion 18 of the system 10 for forming a weld joint in an associated workpiece 20. The power source 14 is connected with the control portion 12 using suitable electrical lead wires 22 and the like in a manner well known in the art. A switch 24 is illustrated schematically for selectively connecting and disconnecting electrical power for flow between the power source 14 and the working portion 18. A return electrical path (not shown) is established between the workpiece 20 and the control 12 or power source 14 using techniques well known in the art.

With continued reference to FIG. 1, a weld wire 60 is illustrated being fed through a weld gun 26 and through a weld tip 28 onto workpiece 20. In accordance with the present application, as the weld wire 60 is fed through weld tip 28, the weld wire substantially maintains its position with respect to the welding tip, thereby forming a more consistently positioned weld bead on the associated workpiece 20. As illustrated in the figure, the weld wire 60 is payed off from a spool 30 suitably positioned in the weld wire storage portion 16 of the arc welding system 10.

It is to be appreciated that common industry practice has heretofore taught that weld wire unwound from a spool should be “killed.” In other words, the memory of the weld wire should be removed prior to the weld wire being wound onto a spool of weld wire. As such, when weld wire is unwound from a spool such as generally illustrated in FIG. 1, and subsequently directly fed into a welding machine and through a welding gun during the welding operation, the weld wire has no retained shape memory characteristics. In addition, the loss of memory in the weld wire makes the weld wire more susceptible to kinks or bends as the weld wire travels through the welding gun, thereby resulting in added inconsistent weld bead placement and the possibility of formation of a low quality weld bead. Further, as the “killed” weld wire is wound onto the spool, the weld wire adopts a shape during the winding process. Furthermore, as the weld wire is unwound from the spool, the weld wire adopts another shape.

In accordance with one prior method, a desires shape memory is imparted onto the weld wire at the time the weld wire is formed and/or at a time subsequent to the weld wire being formed. The shape memory is in the form of a waveform having a relatively small cast, typically having a generally fixed radius of curvature in the range of about 15-40 inches. In one prior method, a substantially linear cast is imparted into the weld wire in the form of an undulating curve including a succession of small generally semi-circular sections defining half cycles of the waveform. The length of each cycle is typically less than about 150 inches, and more typically 40-120 inches, and even more typically 50-100 inches, and still even more typically 60-90 inches.

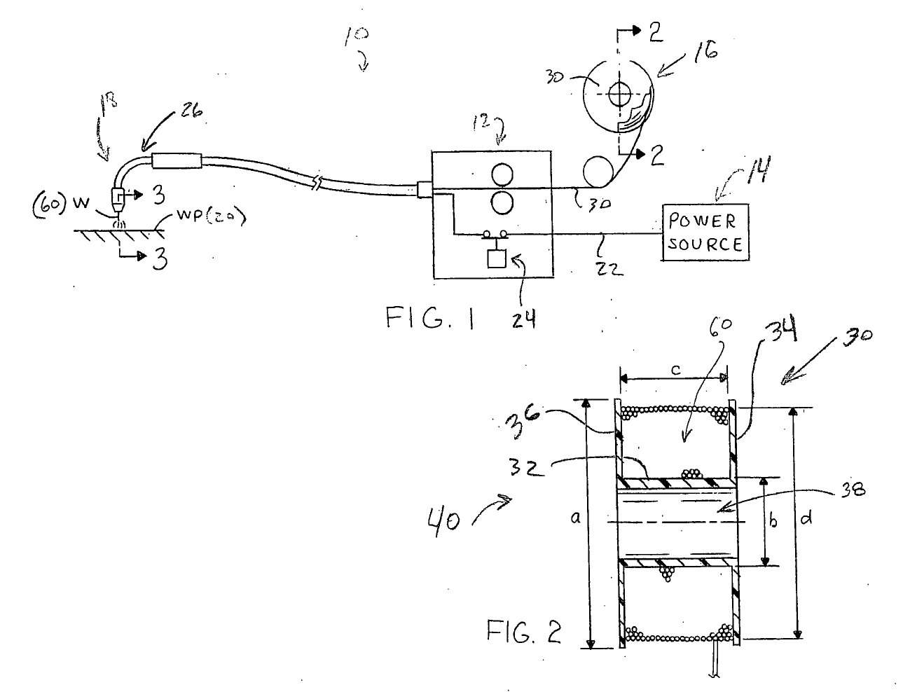

With reference next to FIG. 2, a spool 30 is illustrated for use in the weld wire storage portion 60 of the arc welding system 10 shown in FIG. 1. As illustrated, the spool 30 includes a substantially cylindrical hub portion 32 carrying a first flange member 34 on a first end thereof and a second flange member 36 on a second and opposite end thereof. Although the spool 30 can take on many forms, in the preferred embodiment, the hub portion 30 is substantially hollow and defines a passageway 38 extending through the spool for providing a means for mounting the spool for fixed rotation in the storage portion 16 to enable the spool to rotate relative to the arc welding system 10 as weld wire is payed out therefrom.

As illustrated in the figure, the spool 30 carries weld wire 60 on the hub portion 32 between the first and second flange members 34, 36. In most typical arc welding system applications, the first and second flange members have an overall outer dimension a of 40 inches. In addition, the hub portion 32 of typical prior art spools has an outer diameter dimension b of between about 10-12 inches. Still further, those skilled in the art appreciate that spools 30 holding weld wire 60 are sold in commerce as articles of manufacture 40 for easy replacement into arc welding systems 10 as additional weld wire is needed. In practice, empty spools are simply replaced with packed spool articles 40 as necessary. Typically, spools are traded in commerce carrying 100 pounds of weld wire 60. As can be appreciated, therefore, the spool width c defined between the spaced apart first and second flange members 34, 36 are defined in order to accommodate a build-up layered outer diameter d of weld wire without wasted space and without extending the build-up beyond the outer diameter a which would prevent the spool from being received into the weld storage portion of the associated arc welding system.

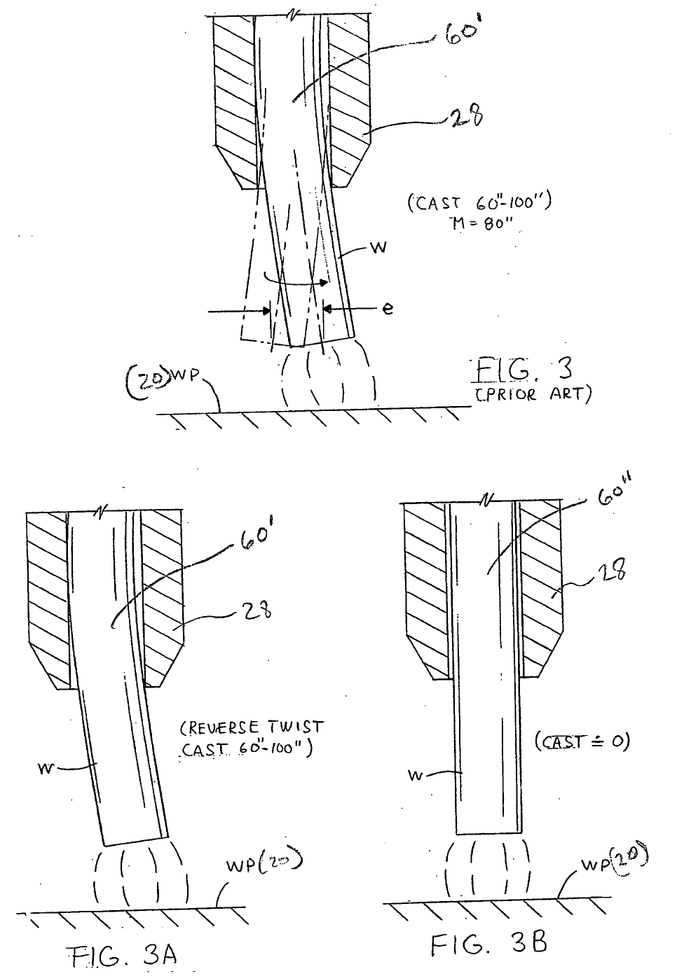

FIGS. 3, 3A, and 3B show the general effects various weld wire characteristics on an arc welding process. Referring first to FIG. 3, a weld wire 60′ is illustrated as being fed through a weld tip 28 of a weld gun 26 of the type illustrated in FIG. 1. The weld wire 60′ has a predetermined desired shape memory formed therein before feeding through the weld tip 28. The shape memory is in the form of a cast having a small generally fixed radius of curvature in the range of about 60-100 inches. The cast is in the form of an undulating curve including a succession of generally semi-circular sections or cycles having a mean average radius of about 80 inches. The length of each cycle is typically less than about 150 inches and typically between 40-120 inches. Weld wires 60′ of the type used in the weld tip 28 shown in FIG. 3 with a small cast e.g. radius of curvature 60-100 inches and mean average radius 80 inches, rotates or “flips” relative to the weld tip 28 as it is being payed out from the spool 30. As the weld wire 60′ flips, the shape memory imparted thereto having a small cast results in movement of the weld wire relative to the tip portion 28 and the associated workpiece 20 illustrated in the figure by complete and partially shaded renderings. To that end, a prior art weld wire 60′ having a shape memory with a small cast “moves” relative to a stationary weld tip 28 and workpiece by a distance e causing a potential inconsistent weld bead placement and the possibility of the formation of the low quality weld bead.

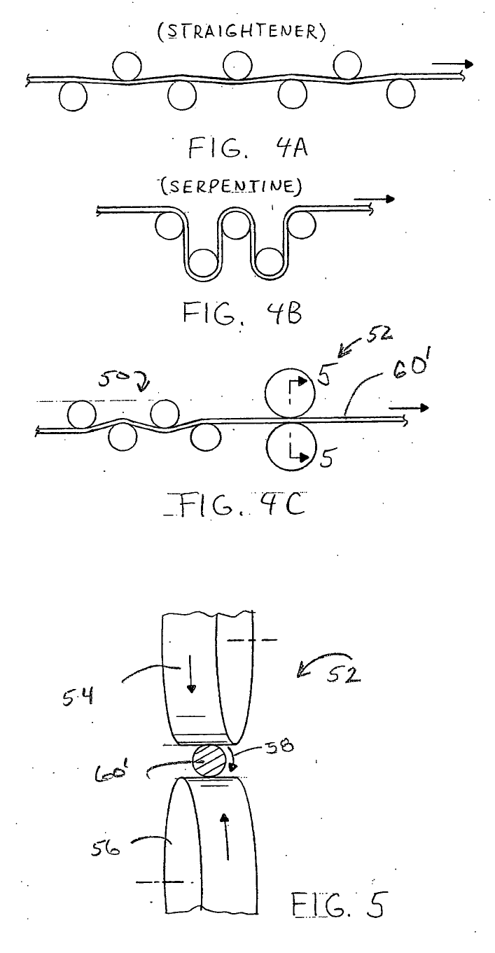

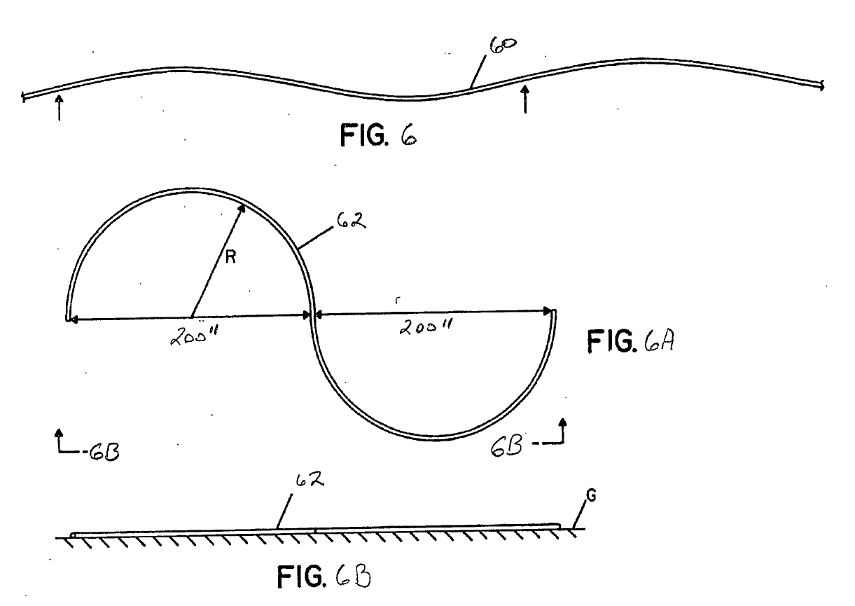

FIG. 3A illustrates the weld wire 60′ discussed above in connection with FIG. 3 being fed through a weld tip 28 towards an associated workpiece 20 during a welding process but using an additional step known in the art as “reverse twist” wire feeding. To that end, references made to FIG. 4C whereat a weld wire 60′ is processed through an arc welding system and is fed by a first roller set 50 towards a reverse twist roller set 52. In the diagrammatic illustration, the first rollers 50 simply direct the weld wire 60′ towards the reverse twist rollers for movement through the associated weld tip 28. As understood by those skilled in the art, the reverse twist rollers 52 function to maintain the relative rotational position of the weld wire 60′ with respect to the welding tip 20 a constant as best possible to thereby form a more consistently positioned weld bead. FIG. 5 shows the set of reverse twist rollers 52 as comprising a pair of opposed upper and lower rollers 54, 56 adapted to engage the weld wire 60′ and impart a counter rotating force 58 in the weld wire in an amount sufficient to overcome the inherent twisting force in the weld wire owing to the shape memory caused by the small cast. Through use of the reverse twist technique, even weld wires having a small cast such as including a radius of curvature of 60-100 inches, a relatively well-positioned weld bead can be formed as shown in FIG. 3A as the weld wire is forced by the reverse twist rollers to maintain its position with respect to the welding tip and associated workpiece. However, the reverse twist step is expensive and not very consistent. In addition, if sufficient force is not maintained between the upper and lower rollers 54, 56 during the reverse twist process, the weld wire could lose the counter rotating force 58 formed in accordance with the present application causing random inconsistencies in the position of the weld wire with respect to the welding tip and workpiece, thereby forming an inconsistent weld bead.

FIG. 3B shows an ideal weld bead forming situation wherein the weld wire 60″is essentially a rod, that is, the weld wire 60′ has no cast or a cast of zero degrees. There, the weld wire 60″ is conducted through the weld tip 28 toward the workpiece 20 along essentially a uniform axis defined by the weld tip. In the system of FIG. 3B, the weld wire 60″ experiences no rotational, or “twist” forces and, as illustrated, substantially maintains its position with respect to the welding tip, thereby forming a consistently positioned weld bead. In practice, however, providing a weld wire with a cast of zero inches is impractical, particularly when the wire is carried on a spool.

In addition to being mechanically impractical, the occasional loss of contact between the tip and weld wire temporarily interrupts the electrical circuit therebetween. Typically, this causes arching which generates large amounts of heat in the tip which adversely affects the quality of the weld and makes control over the welding process difficult. The preferred embodiment according to the instant application closely approximates the wire 60″ of FIG. 3B in the desirable aspect of minimal lateral movement relative to the welding tip. However, it maintains mechanical contact with the inner channel of the tip, thus preventing the undesirable heat causing arching phenomena described above.

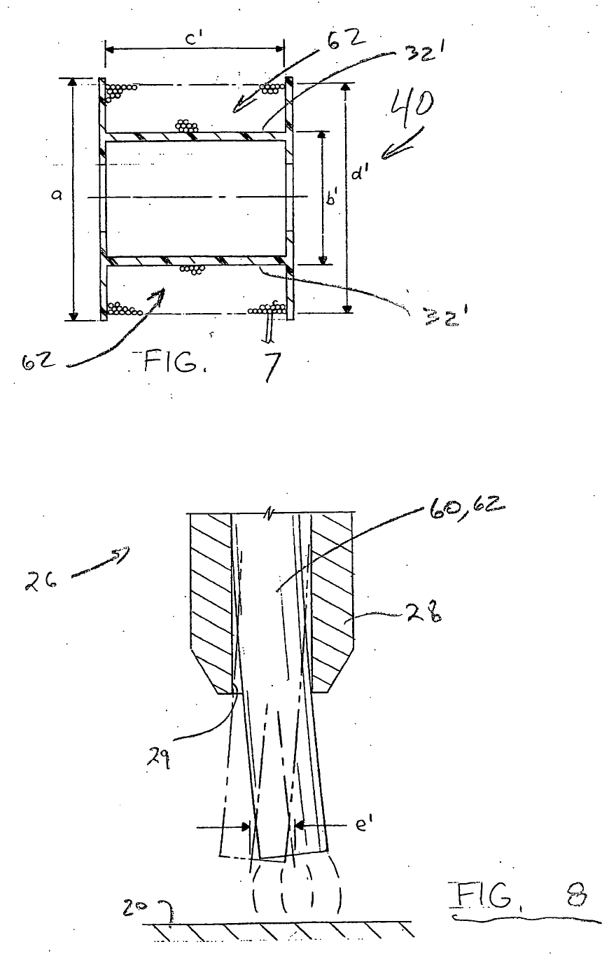

Referring now to FIG. 6, the improved weld wire 60 having an imparted desired shape memory is illustrated. Weld wire 60 deviates from common industry practice by maintaining or creating shape memory having a large cast in the weld wire as the weld wire is wound onto a spool of weld wire or prior to the weld wire being wound onto the spool of weld wire. As such, the weld wire has a desired shape memory when the weld wire is unwound from the spool of weld wire and fed through a welding gun.

Surprising, it has been found that the use of a weld wire having shape memory with a large cast with a mean average radius of not less than 80 inches results in the placement of a weld bead during the welding operation which is more consistent and of a higher quality than weld beads formed by a “killed” weld wire having little or no shape memory or formed by weld wire having a wall cast. The use of the shape memory weld wire with a large cast also has been found to create a more robust weld bead during the welding process.

The desired shape memory imparted onto the weld is preferably imparted onto the weld wire at the time the weld wire is formed. However, it may be imparted at a time subsequent to the weld wire being formed. The weld wire is typically informed by standard wire casting processes; however, other processes can be used such as extrusion and others now know or here. During the casting process, the weld wire has a shape memory imparted onto the weld wire. Initially, the weld wire is first “killed,” using suitable rollers as illustrated in FIGS. 4A and 4B, and the desired shape memory is subsequently imparted onto the weld wire by various other processes such as, but not limited to, a casting process. As can be appreciated, the desired shape memory with a large cast can be imparted onto the weld wire during the forming process for the weld wire. Alternatively, the shape memory imparted onto the weld wire can be fully or partially retained on the weld wire prior to the weld wire being subjected to a subsequent shaping process which imparts the desired shape memory onto the weld wire. Once the shape memory is imparted onto the weld wire, the weld wire is wound onto a spool of weld wire. The shape memory that is imparted onto the weld wire is fully or substantially retained in the weld wire as the weld wire is wound onto the spool and subsequently unwound from the spool prior to being cut and/or inserted and/or fed through a welding machine to form a weld bead onto a workpiece. In its preferred form, the spool includes a hub portion having a diameter adapted to carry the weld wire so that the desired shape memory is substantially retained in the weld wire after the weld wire is unwound from the spool

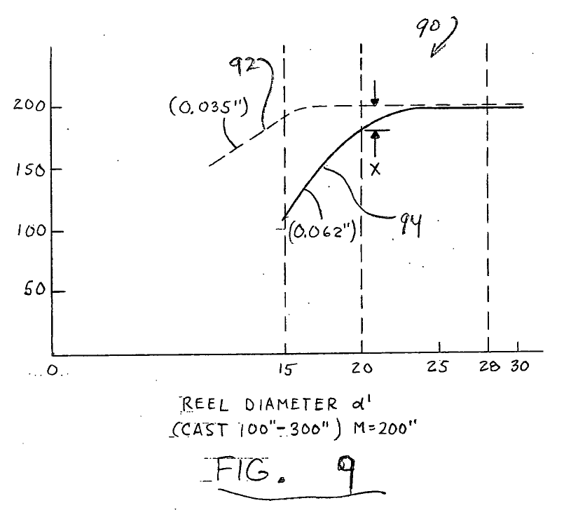

Referring still to FIG. 6, as weld wire 60 is unwound from the spool, the weld wire may or may not have a notable waveform. Indeed, the imparted memory shape onto the weld wire may substantially deviate from the waveform of the weld wire as it is unwound from the spool. As shown in FIGS. 2 and 7, weld wire 60 is unwound from spool 30, 70 while spool 30, 70 is maintained in a non-rotatable position. An arm, not shown, is used to unwind weld wire 60 from the spool resulting in the shape of the weld wire, as shown in FIG. 6. During the unwinding process, the weld wire is typically under tension and does not revert back to its imparted shape unless the weld wire is cut into a weld wire section 62, as illustrated in FIG. 6A. As shown in FIG. 6A, cut weld wire section 62 reverts back into a uniform waveform. The residual stress in weld wire 60 causes the cut weld wire section 62 to revert into the imparted memory shape. As shown in FIG. 6B, when the weld wire section 62 is laid upon a flat ground surface G, the imparted shape memory on the wire is substantially in one plane. As such, the weld wire section 62 substantially does not rise above the flat ground surface. Typically, the cut weld wire section 62 does not deviate from the flat ground surface by more than about 5 inches, more typically less than about 3 inches, still more typically less than about 2 inches, and even more typically less than about 1.5 inches. Deviations that are too large can result in inferior weld bead placement consistency. As shown in FIG. 6A, each half cycle of the waveform is substantially semi-circular and has a mean average radius of about 200 inches. The maximum amplitude of the waveform for each half cycle is generally substantially the same throughout the length of the cut wire section and is preferably in the range of about 100-300 inches, but not less than 100 inches. Typically, the maximum amplitude of each half cycle of the cut weld wire section varies less than about 6 inches, more typically less than about 4 inches, and still more typically less than about 2 inches. Although the maximum amplitude of each half cycle of the cut weld wire section is illustrated as being inches, other maximum amplitudes can be selected depending on the welding process. For most cut weld wire sections, the maximum amplitude of each half cycle is typically in the range of about 100-300 inches, more typically about 150-250 inches, and even more typically about 175-225 inches. Preferably, the mean average radius of curvature is about 200 inches, but not less than about 80 inches. As shown in FIGS. 6A and 6B, the length of each half cycle of the waveform of the cut weld wire section is substantially the same. Typically, the deviation of each half cycle will vary less than about 6 inches, more typically less than about 4 inches, still more typically less than about 2 inches, and even more typically less than 1.5 inches. In addition, the length of each cycle of a cut section of the weld wire typically is substantially the same. The length can vary somewhat based upon the position of the weld wire on spool 30 as it is unwound from spool 30. However, such deviation is typically small. Typically, the length of each cycle of the cut weld wire section varies less than about 15 inches, more typically less than about 10 inches, and still more typically less than about 5 inches. The length of each cycle of cut weld wire section can also vary depending on the position of the weld wire as it is unwound from the spool and/or on the diameter of the weld wire. The length of each cycle is typically not less than about 200 inches, and more typically within a range of about 200-600 inches, and even more typically 300-500 inches, and still even more typically 350-450 inches. Other lengths of the cycle can be used. As shown in FIG. 6A, the mean average radius of each one half weld wire cycle is approximately 200 inches but not less than 80 inches, and the length of the weld wire forming the half cycle is about 628 inches.

The waveform of the shape memory weld wire causes the weld wire to flip as the weld wire is fed through the welding tip of the welding gun. This flipping phenomenon results in the weld wire being in substantially the same position relative to the welding tip after each flip rotation as the weld wire is fed through the welding tip, thereby resulting in a more consistent positioning of the weld bead during the welding process. The number of flips of the weld wire is dependent on the number of loops of the weld wire on the spool.

As shown in FIGS. 2 and 7, further in accordance with another embodiment of the present invention, an article of manufacture 40, 40′ is provided in the form of a spool 30, 30′ holding weld wire 60, 62 thereon. Generally, the spool includes a substantially cylindrical hub portion having a diameter adapted to carry the weld wire so that the desired shape memory is substantially retained in the weld wire after the weld wire is unwound from the spool. To that end, the preferred spool has a diameter within a range of about 18-20 inches. In FIG. 2, the weld wire 60′ has a solid core with a diameter of about 0.035 inches. The spool has a hub portion 32 with a diameter b of about 18 inches. In FIG. 7, the weld wire 62 has a solid core and a diameter of about 0.062 inches. The hub portion 32′ has a diameter b′ of about 20 inches. As suggested above, weld wire is typically sold in the industry in 1,000 pound units preloaded onto spools of appropriate outer dimension but not more than 40 inches in outer diameter. In the present application, a first embodiment article of manufacture including a spool 30 carrying weld wire 60 has a hub diameter b of about 18 inches, an overall outer diameter a of 40 inches, and a width c between spool flanges selectable as desired. For larger weld wire 62 such as having a solid core with a diameter of about 0.062 inches, a second embodiment article 40′ includes a spool 30′ having a hub portion 32′ with an outer diameter b′ of about 20 inches. In order for easy loading onto an associated arc welding system, the total outer diameter a′ of the spool 30′ holding the larger diameter weld wire is set to 40 inches. The width c′ of the spool 30′ is selectable as desired in order to accommodate 1,000 pounds of weld wire on a spool having a diameter b′ of about 20 inches.

Referring now to FIG. 8, weld wire 60, 62 is illustrated as being fed through weld gun 26 and through weld tip 28 onto workpiece 20. As weld wire 60, 62 is fed through weld tip 28, the weld wire substantially maintains its position with respect to the welding tip, thereby forming a more consistently positioned weld bead. The wire moves by a small amount e′ relative to the tip as it is fed from the spool and through the weld gun. As shown, weld wire 60, 62 engages passageway 29 of weld tip 28 thereby establishing a good electromechanical contact between the weld tip and the wire. Also, the wire rubs the passageway causing friction between the weld wire and passageway. This friction results in increased melting point friction which imparts a small amount of heat onto the weld wire thereby facilitating in the melting of the weld wire during the formation of the weld bead. Weld wire that is “killed” is merely reshaped in the welding tip, thus resulting in little melting point friction. The shape memory of weld wire 60 resists being reshaped by the welding tip, thus resulting in greater melting point friction being generated as the weld wire passes through the welding tip.

With reference next to FIG. 9, a graph 90 illustrates the preferred relationship between the outer diameter of the spool hub portion versus mean average radius of curvature of shape memory imparted into the weld wire in accordance with the present application. As illustrated there, a first curve 92 represents a weld wire having a diameter of about 0.035 inches and is shown in dashes. A second curve 94 represents the preferred relationship in an article of manufacture including a spool carrying a weld wire having a diameter of about 0.062 inches. As shown in the drawing figure, in order to maintain the preferred mean average radius of curvature of about 200 inches, the hub portion of the spool 30 should be at least 15 inches in diameter for weld wire having a diameter of about 0.035 inches (curve 92) and at least 20 inches for weld wire having a diameter of about 0.062 inches (curve 94). In accordance with the present application, it is preferred that the spool have a substantially cylindrical hub portion with a diameter adapted to carry the weld wire so that the desired imparted shape memory is substantially retained in the weld wire after the weld wire is unwound from the spool. Thus, according to the graph of FIG. 9, as shown by curve 92, a hub portion in a spool should have a diameter of at least 15 inches in order to avoid adversely affecting the desired imparted shape memory formed on the weld wire with a mean average radius of about 200 inches. For weld wire having an outer diameter of about 0.062 inches, the hub portion of the spool 70 in the subject article of manufacture preferably has a diameter of at least 20 inches in order to maintain the desired imparted shape memory in the weld wire having a mean average radius of curvature of about 200 inches. It is to be appreciated, of course, that a spool having a hub portion with a diameter of about 20 inches or greater can be used to accommodate weld wire having an outer diameter of 0.062 inches and less.

The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

1. A weld wire for storage on an associated spool of weld wire, said weld wire having a cast in the form of a succession of generally semi-circular sections defined along the length of the weld wire, said cast having a mean average radius of curvature of about 200 inches, and formed on the weld wire prior to the weld wire being wound on said associated spool and at least partially retained in said weld wire after the weld wire is unwound from said associated spool.

2. The weld wire as defined in claim 1, wherein said succession of semi-circular sections have a generally fixed radius of curvature.

3. The weld wire as defined in claim 2, wherein said generally fixed radius of curvature is at least about 100 inches.

4. The weld wire as defined in claim 3, wherein said generally fixed radius of curvature is in the range of about 100-300 inches.

5. The weld wire as defined-in claim 4, wherein said succession of generally semi-circular sections lie generally in a single plane.

6. The weld wire as defined in claim 1, wherein said cast has a mean average radius of curvature of not less than about 80 inches.

7. The weld wire as defined in claim 1, wherein said succession of semi-circular sections have a radius of curvature in the range of about 100-300 inches.

8. The weld wire as defined in claim 7, wherein said succession of semi-circular sections have a mean average radius of curvature of not less than about 80 inches.

9. The weld wire as defined in claim 1, wherein:
said cast is a substantially linear cast in the form of said succession of generally semi-circular sections.

10. An article of manufacture comprising:
a weld wire having a desired shape memory imparted to the wire during a manufacturing process thereof; and,
a spool including a substantially cylindrical hub portion having a diameter adapted to carry said weld wire so that said desired imparted shape memory is substantially retained in said weld wire after the weld wire is unwound from said spool.

11. The article of manufacture as defined in claim 10, wherein:
the desired imparted shape memory of said weld wire is a substantially linear cast in the form of a succession of generally semi-circular sections having a generally fixed radius of curvature.

12. The article of manufacture as defined in claim 11, wherein:
said generally fixed radius of curvature is at least about 100 inches.

13. The article of manufacture as defined in claim 11, wherein:
said generally fixed radius of curvature is in the range of about 100-300 inches; and,
said diameter of the cylindrical hub portion is in the range of about 18-20 inches.

14. The article of manufacture as defined in claim 10, wherein:
the desired imparted shape memory of said weld wire is a substantially linear cast in the form of a succession of generally semi-circular sections having a mean average radius of about 200 inches; and,
said diameter of the cylindrical hub portion is in the range of about 18-20 inches.

15. The article of manufacture as defined in claim 14, wherein:
said succession of generally semi-circular sections have a mean average radius of not less than 80 inches.

16. The article of manufacture according to claim 10, wherein:
said weld wire has a solid core with a diameter of about 0.035 inches; and,
said diameter of said hub portion of said spool is about 18 inches.

17. The article of manufacture as defined in claim 10, wherein:
said weld wire has a solid core with a diameter of about 0.062 inches; and,
said diameter of said hub portion of said spool is about 20 inches.

18. The article of manufacture as defined in claim 10, wherein:
the desired imparted shape memory of said weld wire is cast in the form of a succession of generally semi-circular sections having a radius of curvature in the range of about 100-300 inches.

19. The article of manufacture as defined in claim 18, wherein
the succession of generally semi-circular sections of said weld wire have a mean average radius of curvature of not less than about 80 inches.

20. The article of manufacture as defined in claim 19, wherein:
the desired imparted shape memory of said weld wire is a substantially linear cast.

21. A method of forming an article of manufacture for welding, the method comprising:
forming said weld wire; and,
imparting a desired shape memory on said weld wire in the form of a semi-circular waveform having a mean average radius of curvature of about 200 inches.

22. The method as defined in claim 21, wherein said imparting includes casting said desired shape memory on said weld wire having a mean average radius of curvature of no less than about 80 inches.

23. The method as defined in claim 21, wherein said desired shape memory is at least partially imparted on said weld wire by a casting process.

24. The method as defined in claim 21, further including:
killing said weld wire prior to imparting said desired shape memory on said weld wire, to at least partially removing a residual shape memory on said weld wire resulting from said forming of said weld wire.

25. The method as defined in claim 21, wherein said shape memory substantially lies in a single plane.

26. The method as defined in claim 21, wherein said waveform has substantially the same maximum amplitude for each half cycle of a full waveform.

27. The method as defined in claim 21, wherein said desired shape memory is at least partially retained on said weld wire as said weld wire passes through a welding tip of a welding machine.

28. The method as defined in claim 21, wherein said imparting includes casting said desired shape memory on said weld wire in the form of a semi-circular waveform with a succession of semi-circular sections having a generally fixed radius of curvature.

29. The method as defined in claim 28, wherein said imparting includes casting said desired shape memory on said weld wire having a generally fixed radius of curvature of at least about 100 inches.

30. The method as defined in claim 29, wherein said imparting includes casting said desired shape memory on said weld wire having a generally fixed radius in the range of about 100-300 inches.

31. The method as defined in claim 21, further including:
providing a spool; and,
winding said weld wire onto said spool.

32. The method as defined in claim 31, wherein:
said providing said spool includes providing a spool including a substantially cylindrical hub portion having a diameter adapted to carry said weld wire so that said desired shape memory is substantially retained in said weld wire after the weld wire is unwound from said spool.

33. The method as defined in claim 32, wherein:
said forming includes forming said weld wire having a solid core with a diameter of about 0.035 inches; and,
said providing includes providing a spool having a hub portion with a diameter of about 18 inches.

34. The method as defined in claim 32, wherein:
said forming includes forming said weld wire having a solid core with a diameter of about 0.062 inches; and,
said providing includes providing a spool having a hub portion with a diameter of about 20 inches.
